(19) United States
(12) Patent Application Publication
(10) Pub. No.: US 2004/0042705 A1
(43) Pub. Date: Mar. 4, 2004

(54) Embedded optical coupling in circuit boards

(76) Inventors: Toshi K. Uchida, Rancho Palos Verdes, CA (US); Masataka Ito, Torrance, CA (US)

Correspondence Address: Natan Epstein, Esq., Law Offices of Natan Epstein, Suite 912, 11377 West Olympic Boulevard, Los Angeles, CA, 90064-1683, US

(21) Appl. No.: 10/230,141

(22) Filed: Aug. 27, 2002

(51) Int. Cl. G02B 6/12

(52) U.S. Cl. 385/14; 385/89; 385/31

(57) ABSTRACT

Optical fibers are embedded in a fiber layer contained between top and bottom surfaces of a circuit board. The optical fibers have fiber ends facing into holes or cavities defined in the insulating board. Optoelectronic emitter and detector elements are mounted in the holes in optical coupling with the fiber ends. The board also has layers of conductive traces for interconnecting electronic components and devices mounted on the board and for electrically connecting the optoelectronic emitter and detector devices to corresponding transmitter and receiver modules.

### BACKGROUND OF THE INVENTION

1. Field of the Invention

This invention pertains to the field of electronic circuit boards used for interconnecting electronic components into functional subassemblies, and more specifically is directed to circuit boards having conventional single or multi-layer conductive traces in combination with an optical fiber interconnect layer embedded between layers of the circuit board.

2. State of the Prior Art

The rapid increase in data transmission and data processing rates brought about by broadband communications and interactive telecommunication and computer services creates a need for increased interconnection density and capacity in electronic equipment. This need has led to a growing reliance upon optical fiber as a replacement for traditional wire transmission lines, and has resulted in the almost complete replacement of copper wire with optical fiber for long distance transmission because of lower transmission losses and superior bandwidth characteristics. Optical fiber transmission can also improve system performance if applied at short distances, as between physically adjacent equipment racks and cabinets, or between offices in a given building. However, the benefits of optical fiber transmission extend to even shorter distances, as at intra-board level among integrated circuits and other components on a single circuit board, and at the intra-module level for interconnecting for example very large scale (VLSI) and ultra large scale (ULSI) integrated circuits and chip subassemblies in a single electronic module operating at Gigabyte speeds.

Advantages of optical interconnects over electrical conductors at the board and module level include immunity to electromagnetic interference (EMI) or electrical noise, electrical isolation of interconnected components, far less frequency dependent signal degradation, and higher possible density of interconnects due to lack of cross-talk between closely spaced, fine conductors.

Current efforts at providing optical interconnects at the circuit board level are exemplified by optical flex technology such as the Optical Flex circuitry marketed by Advanced Interconnection Technology, LLC of Islip, N.Y. and the optical flex foil developed under the Apollo Demonstrator project at the Micro Interconnect Research Center of L M Ericsson, Stockholm, Sweden and described in Ericsson review, No. 2, 1995, vol. 72. In general these optical interconnects involve arranging lengths of optical fibers in a desired pattern customized to the intended application, laminating the optical fibers between sheets of a flexible foil and applying appropriate connectors and terminations to the fiber ends. The lamination holds both the fibers and the connectors in the desired layout. The flex foil interconnect is assembled to a conventional rigid circuit board simply by plugging the connectors to corresponding mating connectors on the circuit board. Mechanical supports may be provided on the circuit board for stabilizing the flex foil in place rather than relying on the fiber connectors alone for this purpose. The flex foil is typically supported in spaced relationship above the electrical components on the board. The resulting assembly tends to be awkward, costly and less than fully reliable due to reliance upon optomechanical connectors and the need to mechanically assemble the optical flex foil to the circuit board.

It has been also suggested in the literature that the flex foil be laminated or bonded to rigid circuit board thereby to integrate optical and electrical interconnects. Even if so laminated, however, current fiber flex foil approaches to the application of optical interconnects at the circuit board level still call for the use of optical connectors and terminations of the fibers and in this regard fall short of true integration of optical and electrical board level interconnections. Furthermore, the laminated flex foil will typically interfere with free layout of electrical parts on the circuit board.

A continuing need exists for better integrated, lower cost and more reliable optical interconnects for electronic circuit boards.

### SUMMARY OF THE INVENTION

This invention addresses the aforementioned need by providing a circuit board with integral optoelectronic connectivity, which includes a board having top and bottom surfaces and a plurality of board edges; optical fibers contained in the insulating material between the top and bottom surfaces, the optical fibers having fiber ends facing into holes defined in the insulating board; and optoelectronic emitter or detector elements mounted in the holes in optical coupling with the fiber ends.

Typically, the optoelectronic circuit board also has electronic circuit devices mounted to the board and electronically connected to the optoelectronic emitter or detector elements such that optical signal communication between the electronic circuit devices is established by way of the optical fibers.

More specifically, the holes each have a hole edge surface between the top and bottom surfaces of the board and the fiber ends extend into the hole through the hole edge surface so as to illuminate or be illuminated by a photo detector or emitter, respectively, mounted in the hole. The optical fiber ends in the holes terminate in a fiber end surface which, in one form of the invention, is transverse, and preferably perpendicular to the top and bottom surfaces and is also substantially flush with the hole edge surface.

The photo emitter or detector elements mounted in the holes each have an optical axis transverse to the top and bottom surfaces and are mounted with the optical axis extending generally vertically into the hole relative to the board top and bottom surfaces, for radiating into or receiving illumination from the hole. The photo emitter/detector elements is each provided with a reflector positioned in the hole so as to place the photo emitter/detector elements in optical coupling with the fiber end surfaces facing into the hole from the hole edge surface.

The optical coupling of the photo emitter/detector elements to the fiber ends in the holes may be diffuse scattered coupling, or the optical coupling may be through a convergent lens disposed for focusing light onto or from the fiber end faces in the holes, or in yet another case the optical coupling may be through a divergent lens disposed for illuminating multiple fiber end faces in a given hole.

In some cases the holes may extend only partially through the board and are open to only one of the top and bottom surfaces. In other cases the holes may extend fully through the board and are open to both the top and bottom surfaces.

The optical fibers of the optoelectronic board may be in the form of an optical interconnect layer which includes top and bottom sheets of electrically insulating material and an intermediate layer between said top and bottom sheets, the optical fibers being included in the intermediate layer. More specifically, the intermediate layer may include one or more fiber carrier sheets with the optical fibers laminated to the fiber carrier sheet or sheets, and the fiber sheets in turn embedded between the top and bottom sheets of electrically insulating material.

Typically, the optical fibers lie in a fiber plane located between and generally parallel to the top and bottom surfaces of the optoelectronic circuit board.

The optoelectronic circuit board may have one or more layers of alternating electrically conductive traces and insulating layers between the top and bottom surfaces of the board and above or below the intermediate layer containing the optical fibers, with through connections for electrically interconnecting electronic components on said board.

These and other improvements, features and advantages of this invention will be better understood by reference to the following detailed description and the accompanying drawings.

### BRIEF DESCRIPTION OF THE DRAWINGS

FIG. 1 is a fragmentary vertical cross section of an optoelectronic circuit board taken along the center axes of a photo emitter/detector pair mounted in corresponding holes and interconnected by an optical fiber embedded in the circuit board;

FIG. 2 is a ray trace diagram of a typical photo emitter/receiver mounted for illuminating an the end surface of an embedded optical fiber in a hole in the circuit board;

FIG. 3 is a perspective view partly in phantom lining depicting multiple optical fiber ends facing into a common hole in the circuit board;

FIG. 4 is a top plan view of the hole of FIG. 3 showing a conical mirror arranged for illuminating the multiple optical fiber ends;

FIG. 5 is a perspective view of an exemplary circuit board with embedded optical interconnects for connecting a high speed microprocessor to multiple data memory modules on the board.

### DETAILED DESCRIPTION OF THE PREFERRED EMBODIMENTS

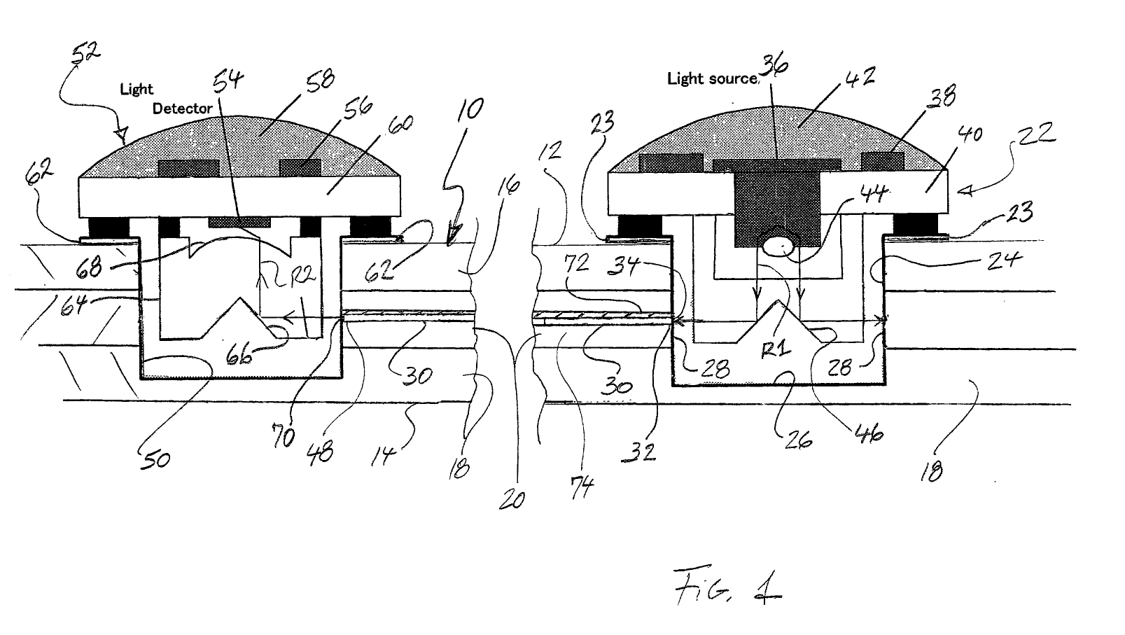

With reference to the accompanying drawings wherein like elements are designated by like numerals, FIG. 1 shows a circuit board 10 which having a top surface 12 and a bottom surface 14. The board 10 has three layers including a top electrical layer 16, a bottom electrical layer 18 and an intermediate optical layer 20. The electrical layers 16, 18 may have conventional copper cladding on one or both sides, that is, on the exterior surfaces 12, 14 and also on interior surfaces facing the intermediate optical layer 20. The board 10 may have still more electrical layers, each with additional copper layers. The layers of copper cladding on the electrical layers may be etched or otherwise processed to define conductive trace patterns for electrically interconnecting electronic components mounted on either or both boards surfaces 12, 14, and with suitable through-connectors (not shown) for making connections between the multiple conductive layers, all in a manner which is well understood in the electronics field. For simplicity and ease of description and illustration, a three layer board is shown in FIG. 1.

A photo emitter unit 22 such as commercially available device SV3637 is mounted on top surface 12 over a hole 24. The hole is open to top surface 12 and has a hole bottom 26 at a depth below the intermediate optical layer 20. The hole 24 also has a side wall surface 28, which may be cylindrical between the top surface 12 and bottom 26. An optical fiber 30 is embedded in the intermediate layer 20 and lies in a plane generally parallel to top and bottom surfaces 12,14. The fiber has a fiber end 32 which extends through the side wall surface 28 of hole 24 and has an end surface 34 which faces into the hole and may be approximately flush with the wall surface 28.

The photo emitter 22 includes a light source 36 such as a light emitting diode or laser diode, and power control IC 38 on submount 40 and encapsulated in a resin 42. The photo emitter 22 is surface mounted to conductive traces 23 which supply the electrical drive signal containing the information to be transmitted by the optical interconnect. The photo emitter converts the electrical drive signal to a light output carrying the same information. The output of light source 36 is collimated by convergent lens 44 onto a conical reflector surface 46 suspended from submount 40 in hole 24 along a vertical optical axis centered in hole 24. Reflector surface 46 is at a 45 degree angle to the vertical optical axis of photo emitter 22 resulting in a 90 degree angle of reflection of the light which is redirected diametrically outwardly against the side wall surface 28 thereby also illuminating the exposed end surface 34 of optical fiber 30. The conical reflector in effect scatters the light output of emitter 22 radially to the vertical axis of the reflector and more or less evenly in a circumferential direction around the cylindrical wall surface 28 of the hole. Because of this two or more optical fibers terminating at the wall surface 28 and having an end surface 34 facing into the hole 24 at circumferentially spaced locations about the wall surface can be illuminated simultaneously by photo emitter 22 as suggested by ray tracings R1. Some fraction of the light output of photo emitter 22 is received by fiber 30 and is transmitted along the length of the fiber. The fiber 30 on the left side of emitter unit 22 runs horizontally within the intermediate layer 20 of the circuit board and terminates in an opposite fiber end 48 at hole 50. A photo detector unit 52 is mounted over hole 50 and includes a photo sensitive element 54 connected to receiver IC 56 encapsulated in resin 58 on submount 60 and surface mounted to conductive traces 62 on top surface 12 of the circuit board. The photo detector 52 may be a commercially available device such as a KPID020 photo detector. The photo detector 52 also has an optical element 64 attached to the underside of submount 60 and suspended coaxially in hole 50. Element 64 is a unitary element of clear material transparent to the light carried by fiber 30 and includes an internal reflecting surface 66, which may be conical and angled at 45 degrees. The top of the optical element 64 is convex and defines a focusing lens 68.

Light carried by fiber 30 to fiber end 48 is emitted through end face 70 generally radially into hole 50 and against reflecting surface 66 which redirects the received light upwardly, as suggested by rays R2, through convex lens 68 which focuses the received light onto photo detector element 54 where the light is converted to an electrical output. This electrical output, carrying the original information of the electrical input to photo emitter 22, is transmitted via conductive traces 62 on top surface 12 of the circuit board to a receiver module or other device for further processing.

The optical fiber 30 will normally be one of many optical fibers in a practical circuit board. The optical fibers lie generally in a common plane approximately parallel to the top and bottom surfaces 12, 14 of the circuit board. Fabrication of the optoelectronic board is facilitated by first laminating the optical fiber 30, and any other fibers of circuit board 10, to one or more flexible carrier sheets or fibersheets 72 in the desired layout pattern. The fibersheet 72 with the laminated fibers is then encapsulated or embedded in a layer of suitable material such as a plastic or epoxy 74 to form the intermediate optical layer 20. The holes 24, 50 can be made by mechanical drilling of the circuit board or by laser drilling. Since the transmission distances on a circuit board are short, relatively loose optical coupling between the fiber end faces and the photo emitter/detector elements is normally sufficient. For this same reason it is not critical that the end faces of the optical fibers be polished to a high degree. Consequently, scattered light directed toward the optical fiber end face will typically deliver sufficient radiation to the fiber core for effective transmission of the optical signal. Similarly, diffuse light emitted at the receiver end of the optical fiber and generally directed onto the photo detector element 54 will normally produce a sufficient electrical output signal from detector unit 52. Transmission of the optical signal is facilitated by use of larger diameter multi mode (MM) optical fiber as the fibers 30 of the circuit board 10, in that multi mode fiber is considerably less demanding than single mode fiber in its degree of coupling to the light emitter/detector elements. The quality of the end surface or facet 34, 70 of the optical fiber 30 can be improved by application of a coating, such as an index matching gel which is commercially available from the Dupont or the Corning companies, among other sources. The facet, which may be somewhat rough as a result of the drilling process, is smoothed by application of the coating thereby enhancing the admission and emission of light in and out of the optical fiber. The facet coating also serves to protect the fiber end surface against oxidation and other processes which would tend to damage or degrade the facet surface.

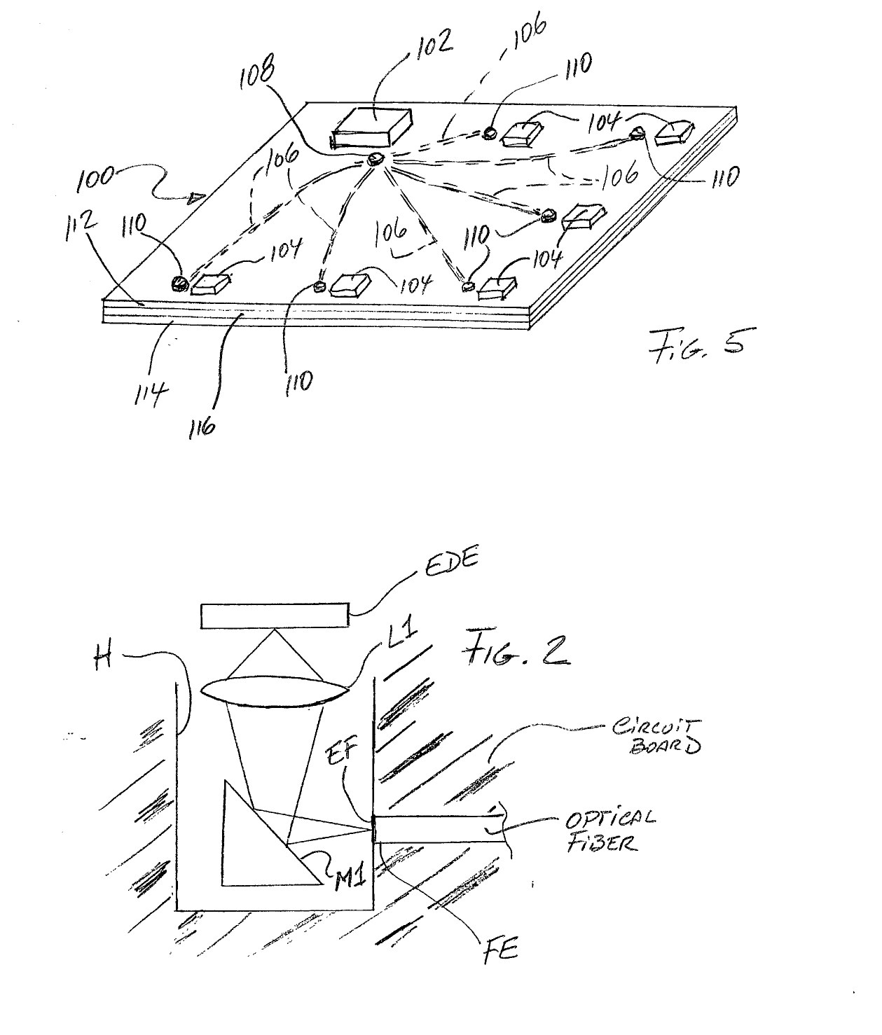

FIG. 2a shows a ray trace diagram of one form of optical coupling of the fiber end FE to a photo emitter/detector element EDE in a hole H of the optoelectronic circuit board. A convergent lens L1 is used in this example in combination with a flat 45 degree mirror surface M1 for focusing the light signal on both the photo emitter/detector element and the end face EF of the optical fiber for efficient coupling. It should be understood that the coupling optics can be arranged and configured in different ways to either tightly focus onto the end face of the fiber or to diffuse the focus over a larger area of the hole's side wall so as to cover the end faces of more than one fiber end facing into the same hole, for example by use of a divergent lens in place of the convergent lens L1.

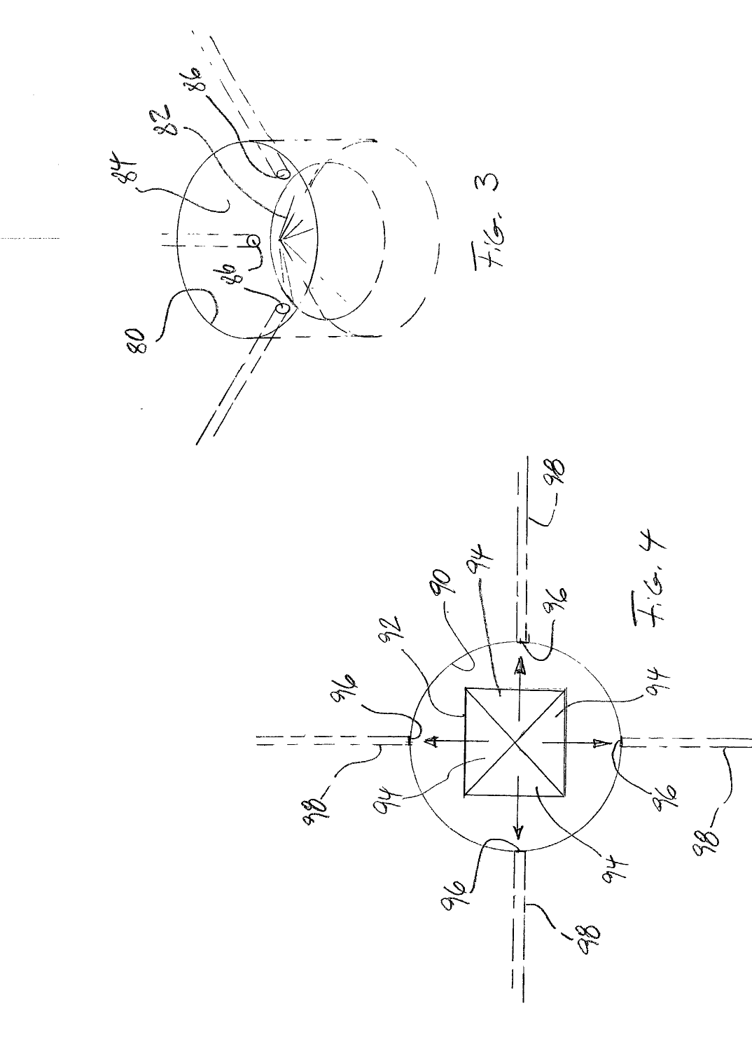

Multiple optical fibers may be terminated in a single hole, as depicted for example in FIGS. 3 and 4. In FIG. 3 a conical reflector 82 in the hole 80 disperses light circumferentially onto the cylindrical side wall 84 of the hole and illuminates the three circumferentially spaced fiber end faces 86 in the hole. In FIG. 4 a four faced pyramidal reflector 92 in hole 90 provides four flat reflecting surfaces 94 each positioned for optically coupling a corresponding one of four optical fiber end faces 96 of embedded optical fibers 98 to a photo emitter/detector mounted above the reflector 92. The flat faces of the polygonal pyramid offers somewhat better coupling efficiency over a circular conical surface.

An example of an optoelectronic circuit board with embedded optical connectivity according to this invention is shown in FIG. 4. In this example the circuit board 100 supports a microprocessor 102 and a number of solid state memory modules 104. Microprocessor 102 outputs a high speed clock signal to synchronous memory modules 104. The high speed clock signal is transmitted to each memory module by a separate optical fiber link 106 embedded in the circuit board in the manner described in connection with FIG. 1. The circuit board 100 has three layers including top and bottom electrical layers 112, 114 respectively and intermediate optical layer 116 containing the optical fibers 106. The optical fiber links 106 are all driven by one common light source 108 arranged in the manner suggested in either FIGS. 3 or 4, with a circular or polygonal conical reflector for illuminating the several fibers 106 with a common light source. Each optical fiber 106 drives a light detector unit 108 adjacent to a corresponding one of the memory modules 104. Electrical connections complete the path from the detector units 110 to the respective memory modules 104. The use of embedded optical connections 106 in optoelectronic circuit board 100 greatly reduces the number of traces and the complexity of the electrical layers of the circuit board and also minimizes radiation of high frequency EMI which would be caused by long conductors carrying the clock frequency throughout the board.

While a preferred embodiment and variants thereof have been described and illustrated for purposed of clarity and example, it will be understood that still other changes, modifications and substitutions will be apparent to those having only ordinary skill in the art without thereby departing from the scope and spirit of the invention, which is defined by the following claims.

What is claimed is:

1. An optoelectronic circuit board comprising:
a board of electrically insulating material having top and bottom surfaces and a plurality of board edges;
optical fibers contained in said insulating material between said top and bottom surfaces said fibers having fiber ends facing into holes defined in said sheet; and
optoelectronic emitter or detector elements mounted in said holes in optical coupling with said fiber ends.

2. The optoelectronic circuit board of claim 1 further comprising electronic circuit devices mounted to said board and electronically connected to said optoelectronic emitter or detector elements such that optical signal communication between said electronic circuit devices is established via said optical fibers.

3. The optoelectronic circuit board of claim 1 wherein said holes have a hole edge surface between said top and bottom surfaces and said fiber ends extend through said hole edge surface into said hole.

4. The optoelectronic circuit board of claim 3 wherein said fiber ends each have an end surface transverse to said top and bottom surfaces.

5. The optoelectronic circuit board of claim 4 wherein said end surface is substantially flush with said hole edge surface.

6. The optoelectronic circuit board of claim 1 wherein said emitter or detector elements each have an optical axis transverse to said top and bottom surfaces, said elements each including a reflector for reflecting said axis towards said fiber ends thereby to place said elements in optical coupling with said fiber ends.

7. The optoelectronic circuit board of claim 1 wherein said board of electrically insulating material comprises a top and bottom sheets of electrically insulating material and an intermediate layer between said top and bottom sheets, said optical fibers being included in said intermediate layer.

8. The optoelectronic circuit board of claim 7 wherein said intermediate layer comprises one or more fiber sheets and said optical fibers are laminated to said one or more fiber carrier sheets.

9. The optoelectronic circuit board of claim 1 wherein said optical fibers lie in a fiber plane located approximately midway between said top and bottom surfaces.

10. The optoelectronic circuit board of claim 1 wherein said holes extend only partially through said board and are open to only one of said top and bottom surfaces.

11. The optoelectronic circuit board of claim 1 wherein said holes extend fully through said board and are open to both said top and bottom surfaces.

12. The optoelectronic circuit board of claim 1 further comprising one or more layers of conductive traces on one or both of said top and bottom surfaces for electrically interconnecting electronic components on said board.

13. The optoelectronic circuit board of claim I wherein said optical coupling is diffuse scattered coupling.

14. The optoelectronic circuit board of claim 1 wherein said optical coupling is through a convergent lens disposed for focusing light onto one or more of said fiber ends in one of said holes.

15. The optoelectronic circuit board of claim 1 wherein said optical coupling is through a divergent lens disposed for illuminating multiple ones of said fiber ends in a common one of said holes.
